(19) United States
(12) Patent Application Publication
(10) Pub. No.: US 2007/0282734 A1
(43) Pub. Date: Dec. 6, 2007

(54) Method and system for the integration of fixed income financial instruments

(76) Inventors: Russell Guy Huntley, North Haledon, NJ (US); Vincent Griffo, Huntington, NY (US)

Correspondence Address: Paul E. Schaafsma, Suite 221, 521 West Superior Street, Chicago, IL, 60610-3135, US

(21) Appl. No.: 11/799,850

(22) Filed: May 2, 2007

Related U.S. Application Data
(60) Provisional application No. 60/746,192, filed on May 2, 2006.

(51) Int. Cl. G06Q 40/00

(52) U.S. Cl. 705/37

(57) ABSTRACT

In accordance with the principles of the present invention, an electronic trading platform for cash and cash futures (options) is provided. The electronic trading platform of the present invention combines the cash and cash futures (options) markets together in a single platform. The cash and cash futures (options) markets can be traded on the same screen. The electronic trading platform of the present invention also brings the cash futures (options) in line with the cash markets. In another aspect of the present invention, the electronic trading platform for cash and cash futures (options) enables the automatic matching of bids and offers. In another aspect of the present invention, an OTC cash future (option) can be provided.

### RELATED APPLICATIONS

This application is based upon U.S. Provisional Patent Application No. 60/746,192 titled “Computer Program Product for the Integration of Fixed Income Securities, Fixed Income Futures and Fixed Income Options on an Electronic Trading Platform” filed 2 May 2006.

### FIELD OF THE INVENTION

The present invention relates to an automated method and system for trading fixed income securities, futures and options.

### BACKGROUND OF THE INVENTION

Fixed income securities can include for example U.S. Treasury notes and bonds, federal agency securities, commercial paper instruments, foreign exchange spot, forwards and options, discount notes, municipal securities, repurchase agreements, and other like security types.

A market for U.S. Treasuries (cash market) has been in existence for a long time. Over time two new markets have evolved from the cash market. They are the Treasury (cash) futures (options) and the repo market. The repo market is a financing market that allows market participants to borrow funds and leverage positions using Treasuries as collateral. A dealer or other holder of government securities sells the securities to a lender and agrees to repurchase them at an agreed future date at an agreed price which will provide the lender with a low risk return. The investor is able to earn additional return above the coupon on the government securities.

Trading volumes in all these markets is significant. In the cash market, the average daily trading volume (ADV) between just dealers and brokers has risen to over $600 billion a day. With deficits at record levels growth in issuance is expected to remain high having a supportive impact on high volume. In addition, the average daily volume of the cash futures market has grown with the volume in the cash market. The average daily trading volume for cash futures market is approximately $204 billion. The U.S. repo market is one of the largest markets in the world. According to figures compiled by the Federal Reserve Bank of New York, cited in a January 2005 Celent report, U.S. primary dealers' average daily outstanding repo positions were $4.8 trillion as of 30 Sep. 2004. There are three types of repos: overnight, open and term. Overnight repos are negotiated on a daily basis. Open repos are repos that have an unspecified repurchase date but can be terminated at any time. Term repos are repos with a term greater than 1 day. Overnight repos are the most common. Term repos trade at a lower volume, approximately $750 billion, because Term repos have risk; repo rates can change and there currently is no efficient hedging vehicle for the repo rate.

Cash and cash futures (options) trade in two different markets. Each market has evolved on its own path with its own conventions. The cash market and the cash futures (options) market have their own unique structures, and even though they are related because they trade the fixed income instrument, they are not truly integrated.

The cash market has traditionally been traded on a non-exchange, negotiated platform with trades being executed by telephone. As volume has increased, this process has slowed down the speed at which participants can enter and transact trades in the market. Technology was developed that allowed the inter-dealer bond market to access real-time, electronic price information for highly liquid products such as Treasuries. However, not desiring full transparency the inter-dealer market only allowed this data to be seen through inter-dealer broker (IDB) screens. These prices were often known to institutional investors through several means. For example, in 1990 GovPx, Inc., Two World Financial Center, South Tower, 225 Liberty Street, New York, N.Y. 10080 was formed to consolidate and publish IDB prices in real time to the market beyond dealers. However, until the late 1990s it was not possible even for dealers to execute trades electronically; they still needed voice interaction. Prices could be viewed on a screen in real time, but execution was still by telephone, meaning that in a fast moving market, the screen price may not have reflected the actual trading price. In 2000, eSpeed, Inc. (110 East 59th Street, New York, N.Y. 10022) began to make the cash market fully electronic. Not only were bid and offer prices shown on the screen, but trades were also executed electronically. Shortly after the launch of eSpeed, a number of dealers wanting to protect market share formed another electronic cash exchange called Brokertek. Brokertek was subsequently acquired by inter-dealer broker ICAP (5th Floor, 2 Broadgate, London, EC2M 7UR) in 2003. Brokertek now has the largest market share of trades executed in the cash market.

The cash market is where the buyer and seller agree in the “here and now” for the purchase and sale of an asset with payment. The actual currency transfer does not occur in the immediate “here and now” but occurs approximately two days following the transaction, but is nevertheless considered in the “here and now”. Cash futures (options) are contracts that are derived from securities in the cash market. As derivatives, they can be defined along two continuums.

A first continuum involves an adjustment for either the delivery and/or the payment at a future date. This is commonly referred to as a forward contract (futures). With a forward (futures) contract, parties can lock in a price today for delivery and/or payment at a date in the future. Forwards (futures) allow the buyer and seller to managed price risk by transferring the risk to the other party. For example, an investor looking to buy a two-year treasury note in 30 days and who likes the price today will enter into a forward contract today in the cash market to buy (go long) the note and take delivery in 30 days. The long has hedged against an increase in interest rates. The seller (short), on the other hand, will take the risk that in 30 days, when (s)he delivers the notes, the notes would have risen in price (i.e. interest rates declined).

A second continuum involves the legal nature of the contracts, of which there are two types. Forward contracts give the parties the obligation to buy (go long) and to sell (go short). Option based contracts give the parties the right to buy (go long) and sell (go short).

Derivative contracts (forwards and options) can be traded in the cash market, which is the over-the-counter (OTC) market. The costs in the OTC market are high, because the OTC market is a market of bilateral agreements. Since trades are bilateral, each party assumes the credit risk of the counterparty. Bilateral agreements impose a credit risk for transactions that will be completed at a future date (i.e. not in the “here-and-now). A transaction is only as good as the party with which a party is trading.

The OTC market is further restricted by the inability to easily assign (novate) the contract to another party without the consent of the contracting counterparty. A counterparty may be unwilling to consent to the assignment (novation) of the agreement to another counterparty who is less credit worthy. Furthermore, even a party with a high credit such as for example an AAA credit rating can have difficulty in the OTC market. For example, a counterparty that is willing to take the other side of the agreement may be prohibited from doing the transaction because of corporate and management controls which may restrict them from having a certain percentage of their derivatives business with that one party. Moreover, because the OTC market consists of bilateral agreements, there is no liquid secondary market for the forwards and options in the cash market. Lack of liquidity also generally results in a lack of transparency. While the cash market has liquidity and transparency, the forwards and options on cash securities traded in the cash market do not.

The OTC market does have a benefit for market participants; it is not overly regulated. The OTC market does not fall directly fall within the jurisdiction of the Securities Exchange Commission (SEC) or the Commodities Futures Trading Commission (CFTC). Market participants have to comply with SEC and CFTC rules and regulations, but the OTC markets are not overseen by either agency. This is because it is deemed to be a market of “professionals” and “high net worth” participants (i.e. those who has total assets in excess of $10 million) or is a market participant, such as a financial institution, a futures commission merchant (FCM), a broker-dealer or a commodity pool with assets exceeding $5 million.

To overcome some of the limitations in the OTC market, futures contracts have evolved. Futures contracts are standardized forward contracts that are multilateral agreements (they have a clearing agent that acts as counterparty to buyer and sellers). The cash futures market started in 1972 with the Market Basket Contract offered by the Chicago Board of Trade (CBOT), 141 West Jackson Boulevard, Chicago, Ill. 60604. The Market Basket Contract allows participants in the cash market to hedge and speculate on bond interest rates. The CBOT also offers options on these futures contracts.

Futures contracts are fungible regarding delivery, quality, and terms. To date, all cash futures and options have been traded on an exchange have been regulated by the CFTC. All the terms of the contract terms are defined except for the price, which is determined by the market. Buyers/sellers deal with an exchange, not with each other. Counterparty risk is removed by a centralized clearinghouse clearing all the trades. The clearinghouse becomes party to both sides of the trade. The clearinghouse intermediates all of the futures transactions. Counterparty credit status becomes irrelevant and the contracts become fungible. The buyer and seller need only worry about the credit status of the clearinghouse. The standardization of the contract and the elimination of credit risk encourage more buyers and sellers to the marketplace and thus improve liquidity.

The clearinghouse manages its risk by requiring that buyers and sellers deposit funds (margins) as security for their transactions and by adjusting these margins to reflect changes in market prices on a daily basis. The contracts are marked-to-market daily which reduces default risk.

Multilateral trading provides liquidity to futures markets. A long and a short can exit their positions by simply offsetting their position prior to settlement (expiration of the contract). The long will short the contract and the short would go long the contract. Profit and losses on the trade would be allocated to the trader's respective margin accounts. The exchange defines rules for settlement of the contract if held until the expiration of the contract.

The Market Basket Contract was designed to protect the floor broker from the “off-floor” traders. It thus has a number of features that do not make it the most efficient of contracts. The Market Basket Contract tracks the cheapest to deliver (CTD) out of a basket of deliverable securities. The result is that the futures price not only does not behave like any one specific Treasury, but behaves like a complex hybrid of notes in the deliverable set, depending on their respective likelihoods of being delivered.

Furthermore, the CTD issues are not the most heavily traded in the cash market. The benchmark issues (the “on the run Treasuries” or last auctioned Treasuries) are the most heavily traded. They account for approximately 80 percent of total trading volume in the cash market. This means the CTD issues have very little floating supply and are much less liquid than the futures contracts themselves. Recently there has been a situation which caused tremendous loses for many investors while a few larger institutions capitalized on accumulation of the CTD issue, creating dislocations in this sector of the market. See, e.g., Gretchen Morgenson, “Was Someone Squeezing Treasuries”, New York Times (7 Aug. 2005); Deborah Lagmarsino, “Treasury Department Examines Short Squeeze in Futures Contract”, Wall Street Journal (9 Aug. 2005).

Most financial futures contracts are settled with physical delivery: the short delivers the underlying asset to the long and the long pays for the asset. This is like a forward contract; but, unlike forward contracts which have a very high level of delivery, less than one half of one percent of all cash futures (options) result in delivery.

This lack of physical delivery could be the result of several factors, such as parties only being interested in hedging price (monetary) risk and who thus do not need to take delivery of the underlying asset; that delivery is too complicated or uncertain so it is not worth considering; that speculators (who never want delivery) are the primary users of the markets; or that the exchanges design their contracts with the sole purpose to eliminate the possibility of delivery fails and in doing so discourage delivery.

Existing cash futures (options) do not encourage the delivery of the underlying fixed income security. This is partly because the cash futures (options) contracts do not “mirror” the heavily traded securities traded in the cash market. The existing cash futures contracts are designed as a basket of fixed income securities, which is not the same as the security being traded in the cash market, which is the newly issued Treasuries that represent 80 percent of the average trading volume. The existing cash futures also allow the short to deliver any security in the basket, which will generally be the cheapest to deliver, and furthermore gives shorts the option to decide when to delivery. In contrast, the fixed income security that is being traded in the cash market is the most recently issued fixed income security, not the cheapest to deliver. Since the long will not be 100 percent sure what will be delivered and when it will be delivered, the long will not want to risk taking delivery.

In addition, failures in the cash futures (options) market are a serious issue with the parties being exposed to large fines and penalties. In contrast, fails in the cash market for fixed income securities are not so serious an issue. Delivery fails occur every day and are a general course of business. The fails are generally remedied over a couple of days without the imposition of fines or penalties. All the failing parties lose is interest earned on the days of failure.

The trading of cash futures (options) has traditionally been transacted in the exchange “pits”. Again, like in the cash market there has been a strong movement to electronic trading platforms. Today more than 70 percent of cash futures (options) are traded electronically.

The cash and cash futures (options) markets focus on different securities. The cash market focuses on newly issued benchmark securities, while the cash futures market focuses on the cheapest to deliver in a basket of fixed income securities.

This lack of consistency between the cash and cash futures markets presents problems for hedgers because of basis risk. Basis risk is where there is a mis-pricing between the cash and cash futures for a specific security. A basis trade is a trade to arbitrage the mis-pricing between the two markets.

Furthermore, since two separate trading platforms exist for the cash and the cash futures (options) markets and each has different execution mechanics, basis (arbitrage) trades can be difficult. The electronic cash futures (options) platforms operate on a cross-matching methodology (best bid/offer). In the cash market, the electronic cross-matching trade has some nuances. The electronic trading platforms in the cash market will not automatically execute a trade if the bid and offer is at par. For a trade to be executed when the bid and offer is at par, somebody has to hit the bid or offer. Furthermore, the electronic trading platforms in the cash market contain a workup, where a dealer can submit an offer for a certain amount at a specific price and another dealer can hit the bid. However, the trade is not automatically executed because the dealer making the offer with a couple of seconds can offer more or the other party can bid more. If the dealer hits that bid, the dealer can offer even more or the other party can bid more at that price. During this time no one gets into the trade. With a workup executing algorithmic trades can be difficult.

Moreover, because of differences between the securities traded in the cash and the cash futures (options) markets, hedge ratios are needed to correlate the cash and cash futures (options). Some traders prefer to weigh the nominal amounts of the cash security and the cash futures by using a conversion factor weighting provided by the futures exchange, while other traders prefer to weigh a basis trade according to a duration-based algorithm.

The cash futures (options) markets, because of their multilateral contract nature and high liquidity, have much lower transaction costs than cash forwards and options traded in the cash market. Margins required to trade and to hold forward positions on fixed income securities in the cash market are several times greater than the margin required to trade and hold futures positions on fixed income securities in the futures market.

FIG. 1 illustrates conventional trading systems for cash, cash futures (options). In this conventional system, the cash futures market has a centralized clearinghouse—the Fixed Income Clearing Corporation (FICC). Parties who want to trade a large position of Treasuries in the cash market generally contact a primary dealer who will put the transaction together or they can trade on eSpeed or Brokertek, where they would need to be a FICC clearing member or a client of a FICC member. For cash futures (options) traders, primary dealers, and customers can all trade directly trade cash futures (options) from the Chicago Board of Trade (CBOT) or Chicago Mercantile Exchange (CME), 20 South Wacker Drive, Chicago, Ill. 60606; they just need to be members of the clearinghouse clearing the trades for the CBOT and CME or have their trades executed through members.

Heavy traders in the cash, cash futures (options) markets rely on the daily netting of their positions to reduce the number of open positions and so minimize risk and improve credit lines. There currently exists daily netting in each of the cash, cash futures (options) and repo markets. However, because the cash and cash futures (options) markets are not filly integrated, it is currently not possible to net the delivery of the underlying fixed income security resulting from the settlement of a cash futures (option).

Still further, the existing cash futures (options) do not have a strong correlation to securities that trade in the cash market. The cash futures (options) is comprised of a basket of stocks of which anyone of a certain term (e.g., for the 10 year note, any treasury older than 6½ years) can be delivered and can be delivered at any time. The Treasury that is normally being tracked is the cheapest to delivery and not the most recently auctioned issue. Thus, a party wishing to hedge the most recent issue or take delivery of the most recent issue in the 10 year treasury futures contract will have basis risk.

The trading cost of fixed income securities (forwards and options) is greater than that for fixed income futures. This may partially be due to the nature of the OTC market and the counterparty credit risk associated with the marketplace. For example, the margins required to trade and hold positions in options on cash United States government securities are several times greater than the margin required to trade and hold positions in options on the same notional amount of cash futures.

What would therefore be desirable would be the extension of a electronic trading platform for the cash, cash futures (options) markets that has features such as greater accuracy, reduced cost, real time market information, more efficient communications over greater distances, and automated record keeping. It would be desirable for a system that allows for the simultaneous trading of the cash, cash futures (options) on the same screen and at the same time. It would be further desirable for a system to trade cash futures (options) in the OTC market in order to remain unregulated by the SEC and CFTC, and not be available to retail customers. It would be further desirable for a system that integrates the markets for cash, cash futures (options). It would be further desirable for a system to reduce basis risk between the cash and cash futures (options) market. It would be further desirable for a system to allow for and encourage delivery of the underlying security. It would be further desirable for a system to allow for and encourage delivery on the underlying fixed income security that is being heavily traded in the cash market. It would be further desirable for a system to net the delivery of the underlying fixed income security resulting from the settlement of a cash futures (option). It would be further desirable for cash futures (option) to “mirror” the underlying fixed income securities that is traded in the cash market using cash market conventions. It would be further desirable for a system to provide automatic matching of trades on a first-in-first-out basis.

### SUMMARY OF THE INVENTION

An electronic trading platform for cash and cash futures (options) in accordance with the principles of the present invention will provide for greater accuracy, reduced cost, real time market information, more efficient communications over greater distances, and automated record keeping.

An electronic trading platform for cash and cash futures (options) in accordance with the principles of the present invention will allow for the simultaneous trading of the cash, futures, and options market on the same screen and at the same time.

An electronic trading platform for cash and cash futures (options) in accordance with the principles of the present invention will result in cash futures (options) trading in the OTC market and so remain unregulated by the SEC and CFTC, and not available to retail customers.

An electronic trading platform for cash and cash futures (options) in accordance e principles of the present invention will integrate the markets for cash and cash (options).

An electronic trading platform for cash and cash futures (options) in accordance with the principles of the present invention will reduce basis risk.

An electronic trading platform for cash and cash futures (options) in accordance with the principles of the present invention will encourage delivery of the underlying fixed income security.

An electronic trading platform for cash and cash futures (options) in accordance with the principles of the present invention will encourage delivery of the underlying fixed income security traded in the cash market.

An electronic trading platform for cash and cash futures (options) in accordance with the principles of the present invention will net the delivery of the underlying fixed income security resulting from the settlement of cash futures (options).

Cash futures (options) in an electronic trading platform in accordance with the principles of the present invention will “mirror” the fixed income securities that are heavily traded in the cash market and use cash market conventions.

An electronic trading platform for cash and cash futures (options) in accordance with the principles of the present invention will provide automatic matching of trades on a first-in-first-out basis.

In accordance with the principles of the present invention, an electronic trading platform for cash and cash futures (options) is provided. The electronic trading platform of the present invention combines the cash and cash futures (options) markets together in a single platform. The cash and cash futures (options) markets can be traded on the same screen. The electronic trading platform of the present invention also brings the cash futures (options) in line with the cash markets. Currently these markets are not aligned as the cash future is tracking the cheapest to deliver out of a basket and not the benchmark issues.

In accordance with the principles of the present invention, the electronic trading platform for cash and cash futures (options) enables the trading of cash futures (options) contracts in the over-the-counter market; however, unlike OTC market, where the trades are bilateral, trades are multilateral cleared through a clearing agent.

Dealers who are clearing members of the futures clearing agent can execute trades and submit those trades directly to the futures clearing agent (electronically or by voice) or they can execute the trades for their clients on the electronic trading platform of the present invention. Even if the dealers submitted the trades directly to the clearing agent, they can subsequently unwind them on the electronic trading platform of the present invention. This creates fungibility for the cash futures (options) even if there is more than one electronic trading system.

In accordance with the principles of the present invention, the electronic trading platform for cash and cash futures (options) enables the automatic matching of bids and offers.

In another aspect of the present invention, an OTC cash future (option) can be provided. This OTC cash futures (option) of the present invention is a single issue security and not a basket for cheapest to deliver. This OTC cash futures (option) of the present invention may be the first futures contract (standardized forward contract that is centrally cleared) traded in the OTC market. In another aspect of the present invention, this OTC cash future (option) of the present invention may be the first futures contract where delivery of the underlying asset is netted and settled in the spot (cash) market. This OTC cash future (option) of the present invention will provide implied repo rates (forward repo rate) and assist in Term repo trades.

### BRIEF DESCRIPTION OF THE DRAWINGS

FIG. 1 illustrates conventional trading systems for cash and cash futures (options).

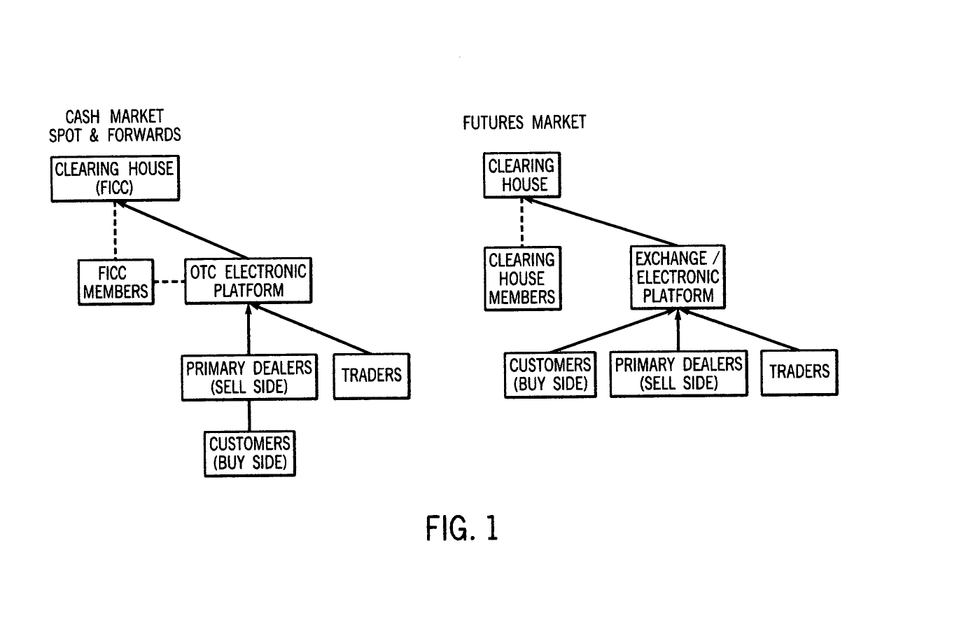

FIG. 2 illustrates an example over the counter electronic platform for the execution of cash securities and cash futures (options) of the present invention.

FIG. 3 illustrates a flow-chart of trading cash securities and cash futures (options) of the present invention.

FIG. 4 illustrates an example of a trading screen that can be used in implementing the present invention.

FIG. 5 illustrates examples of products that can be traded on the electronic platform.

### DETAILED DESCRIPTION OF THE INVENTION

The invention itself, together with further objects and attendant advantages, will be understood by reference to the following description, taken in conjunction with the accompanying drawings. As those skilled in the art will appreciate, the system described herein should accommodate a plurality of financial markets.

In summary, the present invention provides an automated trading platform which enables institutional investors, broker dealers, and others to transact and trade directly and anonymously in the cash and cash futures (options) markets. With the present invention, traders will have access and outright execution to cash and cash futures (options) markets on a single platform. Furthermore, with the present invention, the cash and cash futures (options) will be made more inter-related, offering traders alternatives and more efficient ways to transact trades across the cash and cash futures markets.

In one embodiment of the present invention, computer systems are utilized in conjunction with an electronic communications network (ECN) to facilitate the trading of fixed income securities, fixed income futures and fixed income options. An electronic trading platform can be based on three components: mainframe computers (host); communications servers; and the exchange participants' computers (client). The operations of the system can cover order-matching, maintaining order books and positions, price information, and managing and updating the database for the trading day as well as nightly batch runs. The host computer can also be equipped with external interfaces that maintain uninterrupted online contact to quote vendors and other price information systems. Traders can link to the host through for example high speed data lines, high speed communications servers, the Internet, and the like. Irrespective of the way in which a connection is established, the computers of the trading systems participants allow traders to participate in the market.

In another embodiment of the present invention, software can be provided to create specialized interactive trading screens on the computers of the trading systems participants for the trading of cash, cash futures (options). The electronic trading platform can provide for the simultaneous electronic trading among fixed income securities, fixed income futures, and fixed income options markets through the same trading screen on a single trading platform. When used herein, the term “the same screen” is not meant to require a single display but rather can include an integrated display of several displays.

In another embodiment of the present invention, a first-in-first-out (FIFO) matching engine can be provided for the cash and cash futures (options) markets. This will help eliminate delays in the cash market resulting from buyers/sellers workup time and help improve execution speed. In the prior art, trading platforms have a workup. For example, assume Party A offers $100 for 10 million, and Party B hits the bid. Party A then offers 20 million. It gets accepted by Party B. Party A then offers 30 million. This can go on indefinitely. During this time no one else can get into the trade.

By automatically matching the bid/offer price, the trade in the present invention is executed instantaneously and there in no time delay. Moreover, there is no time delay for another trader wanting to execute a bid/offer that previously had to wait for the workup to be completed. In addition, the electronic market place of the present invention provides for an automatic matching of bids and offers in the cash market even if the bid and offer are at par. For example, if dealer A bids $100 for 10 m and dealer B offers 10 m at $100 a trade will not occur until someone either hits the bid or takes the offer. The speed of execution in the present invention provides suits ‘black box’ (algorithmic) trades which are becoming a significant participant in liquid electronically traded markets.

The present invention will allow users to view and trade on prices in the system as well as the available amount at each price. This will allow users to better gauge liquidity at different prices to make improved directional and timing decisions.

In another embodiment of the present invention, the electronic trading platform can have specifically designed deliverable single issue cash futures (options). The single issue cash futures (options) of the present invention will mirror the newly issued securities traded in the cash market. The single issue cash futures (options) specifications of the present invention will match and conform to the trading conventions of the underlying fixed income securities cash market. The cash futures (option) can deliver a specific fixed income security at a specific future date using market delivery methods. The single issue cash futures (options) specifications will reflect the auction cycle, issue date, settlement date, and coupon payment date structure of the delivery of a specific issue, not the market basket or the cheapest-to-deliver (which will change over time) fixed income security of the existing fixed income futures and fixed income options contracts. The single issue cash futures (options) of the present invention will track individual cash securities. This mirroring will reduce basis risk.

In another embodiment of the present invention, open cash futures (options) can, at settlement, result in the delivery of the underlying fixed income security. If the short has an open position at settlement, the short will be required to make delivery of the underlying instrument, and likewise the long will have to take purchase the underlying instrument.

In another embodiment of the present invention, the cash futures (options) of the present invention for the underlying fixed income security can be cleared through a centralized clearinghouse that will become a counterparty to the trade and guarantee payments due to the long or short. The clearinghouse for the cash futures (options) of the present invention for the underlying fixed income security can, at settlement of the cash futures (options), transfer the delivery and payments obligation of the long and short to the appropriate centralized clearinghouse for the cash market (e.g. FICC). This will guarantee payment to the long of an amount owed to the long from the short as a result of the contract and will guarantee payment to the seller of an amount owed to the seller from the buyer as a result of the trade.

In the cash market there are fails everyday. Fails in the cash market for fixed income securities are not so serious an issue. The penalty is that the party failing to deliver in this market is that it will have to pay interest on the coupon. Failure in the futures markets is a serious issue with the parties being exposed to large fines and penalties. That is one reason why so few futures contracts results in delivery. The present invention is novel in that the cash futures (options) net and settle at FICC. This eliminates the headaches of delivery fail at the clearing agent for the futures (options) contract. The clearing agent for the futures (options) contract will net trades at settlement, and will then determine delivery obligations and forward that information to FICC. The trades can then be netted at FICC. The netting improves credit lines.

In another embodiment of the present invention, the centralized clearinghouse for the cash and cash futures (options) of the present invention can also enter into a cross-margining relationship to cover the time period from the time of settlement of the fixed income futures and fixed income options contracts until the time the obligations of the long and short are transferred to the centralized clearinghouse in the cash market.

In another embodiment of the present invention, the cash futures (options) will be traded in the OTC market. The present invention may be the first platform to trade futures contracts in the OTC market. The advantages of an OTC marketplace is that traders who are clearing members of the clearing agent can execute trades and submit those trades directly to the clearing agent or they can execute the trades for their clients on the electronic market place of the present invention. Even if the dealers submitted the trades directly to the clearing agent, they can subsequently unwind them on the electronic market place of the present invention. Under the present invention, there is fungibility even if the cash futures (options) trade on more than one electronic alternative trading platform.

In another embodiment of the present invention, the cash futures (options) of the present invention can have any or a variety of settlement dates (e.g., 1 day, 10 days, 30 days or 90 days).

In another aspect of the present invention, the cash futures (options) offer traders a correlated hedge and address the hedge ratio mismatches associated with other cash futures (options).

In another aspect of the present invention, the cash futures (options) can provide the ability to short the cash market without borrowing, which may reduce arbitrage spread and costs.

In another aspect of the present invention, because the cash futures (options) are well correlated to the underlying cash market, central banks who are large holder of securities in the cash market can minimize interest rate risk by shorting the cash futures contract. Central banks are restricted from short selling the cash market.

In another aspect of the present invention, as a clearinghouse cleared product, the cash futures (options) can net down financing trade exposure and move those netted positions “off balance sheet”.

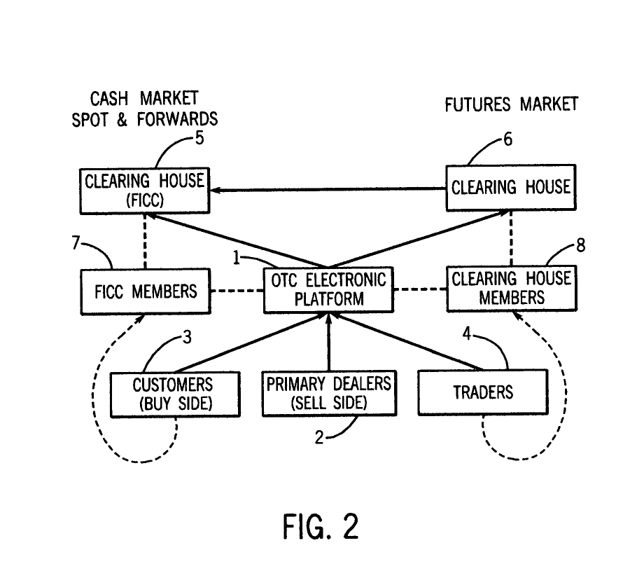

Referring now to FIG. 2, an OTC electronic platform 10 in accordance with the principles of the present invention allows for the execution of cash, cash futures (options) of the present invention on the same electronic platform and the same trading screen. Cash trades are cleared by a centralized clearinghouse for the cash market 5. Cash futures (options) are cleared by a centralized clearinghouse for the futures market 6. Customers 3, primary dealers 2, and traders 4 will be members of the cash clearinghouse or trade through a member of the cash clearinghouse 7. Customers 3, primary dealers 2, and traders 4 will be members of the futures clearinghouse or trade through a member of the futures clearinghouse (FCM) 7. The futures clearinghouse 6 and the cash clearinghouse 5 will agree to allow for the delivery of the underlying fixed income security at the expiration of the novel fixed income futures and options contracts in the cash clearinghouse 5.

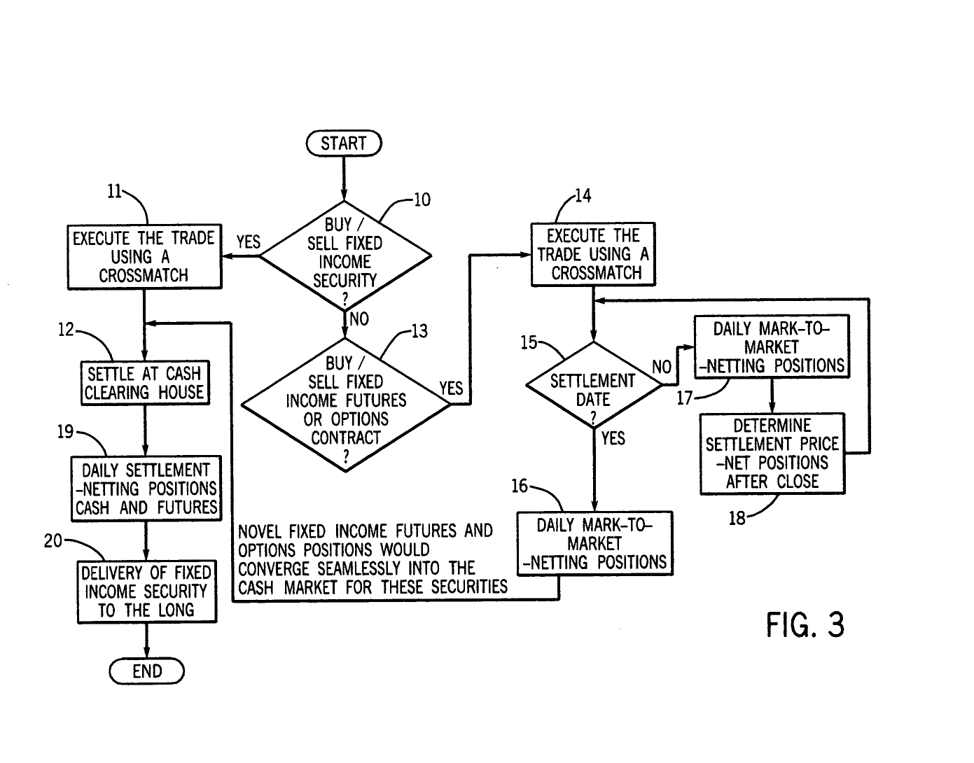

Referring to FIG. 3, a trader will decide whether to trade the fixed income security or the cash futures (option), or trade both simultaneously. If (s)he buys/sells a fixed income security 10, the OTC electronic trading platform 10 of the present invention will execute a cross-matching trade 11. The trade data will be submitted to the clearinghouse for the cash market 5. The clearinghouse for the cash market 5 will settle and net the trades at the end of the day 9. Once the trades are settled, a short will be required to make delivery 20 of a fixed income security to a long. If (s)he buys/sells the cash futures (options) 13, the OTC electronic platform 10 of the present invention will execute the trade and forward the trade data to the clearinghouse for the futures and options 6. A determination will be made at the futures and options clearinghouse 6 whether it is a settlement day for the cash futures (options) 15. If it is not, then the trades go through daily marked-to-market and netting 17 and margin accounts of parties with open positions will be credited/debited 18. If it is a settlement for the cash futures (options), then the clearinghouse for the futures and options 6 will settle and net the open positions. The futures and options clearinghouse 6 will then forward the data to the clearinghouse for the cash market 5, which will then process the underlying securities in its daily settlement and netting process.

In another embodiment of the present invention, real-time prices for more liquid products can be displayed, while gaining voice brokered pricing and execution on less liquid products.

In another embodiment of the present invention, the electronic trading platform can allow specific trades such as basis trades and yield trades to be executed efficiently and at speed. On the screen there will be a bid and offer price for the basis and yield trades. The trade can be executed efficiently and rapidly because the cash security underlying the cash futures contract mirrors the security in the cash market.

In another embodiment of the present invention, this invention will allow for the underlying cash, cash futures (options) to be priced in any currency for delivery anywhere in the world.

In another embodiment of the present invention price improvement can be provided. If a user attempts to buy or sell at one rate and the price improves during the execution process, the client will receive the benefit of the improved price. Best bid and offer and trade execution can be provided.

In another embodiment of the present invention, an anonymous trading environment can be provided. The identity of the user, coupled with the associated trade details, will only be revealed to the user's clearing banks back office.

In the electronic market place of the present invention primary brokers can exchange in large block trades each of the cash and cash futures (options) through a novel block trading system. A party that wants to offer/bid for example $200 million at a specific price, may not want to show the full amount (maybe only $20 million). The $20 million will show up on the screen and the remaining $180 million will go into a block system. If the $20 million is transacted, another $20 million will pop into the screen at the same price.

In another embodiment of the present invention, fixed income security traders can preserve their credit lines and balance sheet by using the cash futures (options) to duplicate a trade that could be done in the cash market.

In another aspect of the present invention, the cash futures will provide repo traders with a product that will enhance the term and open repo trades. Since the cash futures price is a forward settled price of the underlying cash market, the differential in price will be the implied repo rate, which will be a function of the total carry to the settlement date. The real-time implied repo rate can be published for each listed cash security to the end dates for each cash futures contract. The implied repo rate (IRR) can be derived from:
IRR=((100*CR*d/360)−v))*360/d
Where
   CR=coupon rate
   d=# of days to settlement
   V=price difference between cash and futures

For example, on 1 Sep. 2007, 100 mm of the 2 yr (4% Aug. 31, 2007) SEP BASIS is purchased at 2/32s. SEP futures expire Sep 30. The IRR can be calculated as follows:
IRR=((100*CR*d/360)−V))*360/d
IRR=((100*0.04*30/360)−0.0625)*360/30
IRR=(0.333−0.0625)*12
IRR=3.25

The present invention will be first futures contract that will be able to provide an implied repo rate. This is because to date, there has not been a futures contract that follows a single issue deliverable in the cash market.

The present invention will be the first significant new arbitrage (cash vs. cash futures vs. repo) facility to come to market since the strip market 20 years ago. The price differential between the cash market and the cash futures contracts will reflect the difference between the current yield and the repo financing rate. This difference in price creates a potential pure arbitrage since locking in a Term repo on the cash position to the expiration date of the futures is a cash flow match.

The present invention will enable traders to automatically input contingent orders, which will help maximize their profit. In other words traders will be able to structure for example an order to buy cash 2 yrs at 99-27 if (s)he can sell 2 YR F SEP at 99−26+ good till cancel (GTC).

Participants in the cash market and the repo market can use the present invention to achieve the same results that would be achieved in the cash and repo markets. Furthermore, market participants that want to take delivery of securities underlying the cash futures (options) can now do so. With the present invention, the long will know what they will be receiving on settlement day. With the present invention the long will know when they will get delivery.

The present invention also allows for easy shorting of the cash market. Shorting the cash market requires two transactions: selling the stock and doing a reverse repo to reverse in the stock. Both transactions are balance sheet items, which will impact credit lines. Because the present invention has a one-on-one relationship with the underlying treasury, a party in the cash market can simply short the present invention contract in one easy step. This will reduce impact to the balance sheet and improve credit lines.

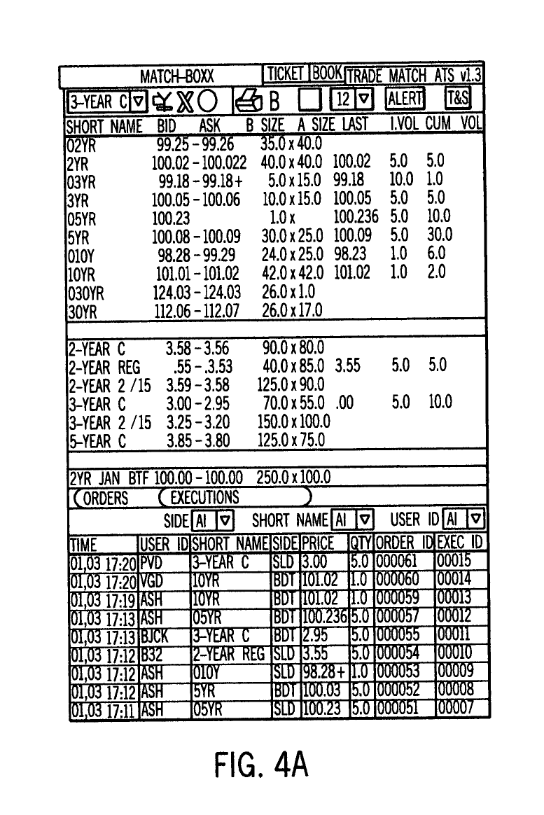

FIG. 4 shows an example of a trading screen that can be used in implementing the present invention. The trading screen includes pull down windows so the screen can change in accordance with what the trader wants to trade. The screen for trading purposes can have for example the following information: the name of the security/futures (e.g., for cash the 2 yr OTR, for futures the 2 yr BTF), the bid/ask prices, bid/ask size, trade size, last trade size, and cumulative volume. For the Term repo the implied repo rate can be shown. The cash futures (options) listed on the screen can be for the most recently issued benchmark Treasury, the current benchmark Treasury and the upcoming benchmark Treasury.

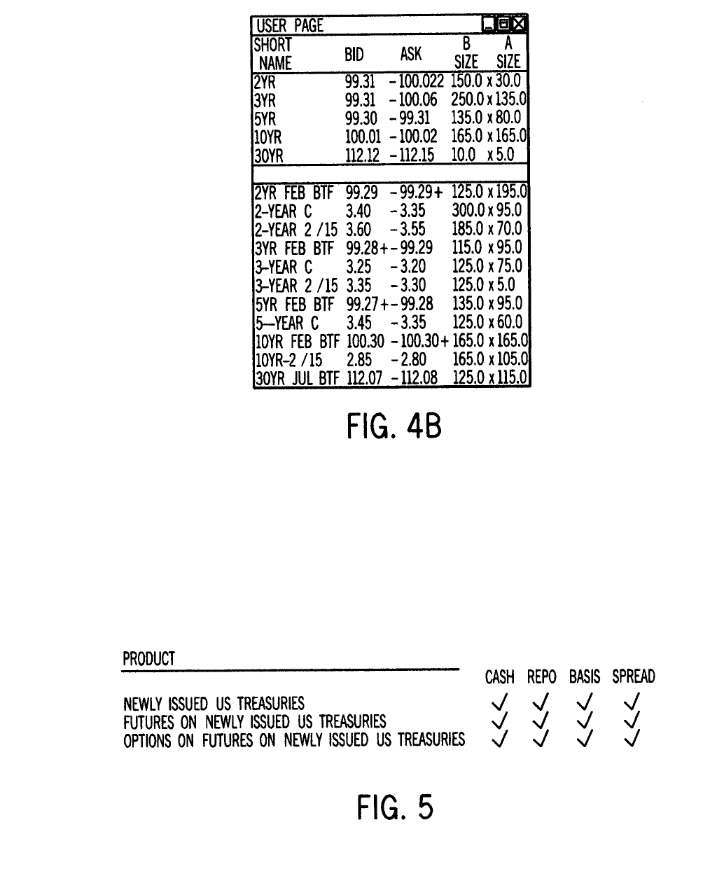

FIG. 5 shows the inter-relationship between the products traded the on the electronic platform of the present invention. Not only are the newly issued Treasuries traded in the cash, cash futures, and cash options market, but it would also be possible to execute a term or open repo trade with the cash futures (options). One can lock in the implied repo rate. Combining two trades for the same security, one in each market, offers the ability to execute a basis (arbitrage) trade. Doing two trades in the same market or in two different markets on two different securities (e.g., the 2 year and the 10 year) offers the ability to execute a yield curve trade.

Thus, in accordance with the principles of the present invention an electronic market place that brings buyers and sellers together is provided. The electronic market place of the present invention will be the first platform that combines the cash, cash futures (options) and cash repo markets together. The cash, cash futures (options) and cash repo markets can all be traded on the same screen. The cash, cash futures and cash repo markets together also brings the cash futures in line with the cash and repo markets. Currently they are not aligned as the cash future is tracking the cheapest to deliver out of a basket and not the benchmark issues.

It should be understood that various changes and modifications preferred in to the embodiment described herein would be apparent to those skilled in the art. Such changes and modifications can be made without departing from the spirit and scope of the present invention and without diminishing its attendant advantages. It is therefore intended that such changes and modifications be covered by the appended claims.

What is claimed is:

1. An electronic trading platform for cash and cash futures (options) comprising:
a fixed income cash market;
a fixed income cash futures (options) market; and
the fixed income cash market and the fixed income cash futures market integrated in a single platform.

2. The electronic trading platform of claim 1 further wherein the cash and cash futures (options) are selected from the group comprising U.S. treasuries, futures on U.S. treasuries, options on U.S. treasuries, and combinations thereof.

3. The electronic trading platform of claim 1 further comprising fixed income futures and fixed income options that mirror an underlying fixed income security.

4. The electronic trading platform of claim 1 further comprising an anonymous trading environment wherein trades can be executed anonymously.

5. The electronic trading platform of claim 1 further comprising a first-in-first-out (FIFO) matching engine.

6. The electronic trading platform of claim 1 further comprising simultaneous electronic trading among fixed income securities, fixed income futures, and fixed income options on a single trading platform.

7. The electronic trading platform of claim 1 further comprising, at settlement, open fixed income futures and fixed income options result in the delivery of an underlying fixed income security.

8. The electronic trading platform of claim 1 further comprising, at settlement, fixed income futures and fixed income options being cleared through a centralized clearinghouse.

9. The electronic trading platform of claim 1 further comprising, at settlement, a netting of open fixed income futures and fixed income options.

10. The electronic trading platform of claim 1 further comprising delivery fails that occur as a result of a fail in the fixed income futures or fixed income options occurring in the cash market.

11. The electronic trading platform of claim 1 further comprising a host, a communications server, and a client.

12. A method of trading cash and cash futures (options) comprising integrating a fixed income cash market and a fixed income cash futures market in a single platform.

13. The method of trading of claim 12 further including selecting the cash and cash futures (options) from the group comprising U.S. treasuries, futures on U.S. treasuries, options on U.S. treasuries, and combinations thereof.

14. The method of trading of claim 12 further comprising fixed income futures and fixed income options that mirror an underlying fixed income security.

15. The method of trading of claim 12 further comprising matching on a first-in-first-out (FIFO) basis.

16. The method of trading of claim 12 further comprising simultaneous electronic trading among fixed income securities, fixed income futures, and fixed income options markets on a single trading platform.

17. The method of trading of claim 12 further comprising, at settlement, open fixed income futures and fixed income options result in the delivery of an underlying fixed income security.

18. The method of trading of claim 12 further comprising, at settlement, fixed income futures and fixed income options being cleared through a centralized clearinghouse.

19. The method of trading of claim 12 further comprising, at settlement, a netting of open fixed income futures and fixed income options.

20. The method of trading of claim 12 further comprising delivery fails that occur as a result of a fail in the fixed income futures or fixed income options occurring in the cash market.

21. The method of trading of claim 12 further comprising a host, a communications server, and a client.

22. An electronic trading platform for cash and cash futures (options) comprising simultaneous electronic trading among fixed income securities, fixed income futures, and fixed income options markets on a single platform.

23. The electronic trading platform of claim 22 further wherein the cash and cash futures (options) are selected from the group comprising U.S. treasuries, futures on U.S. treasuries, options on U.S. treasuries, and combinations thereof.

24. The electronic trading platform of claim 22 further comprising fixed income futures and fixed income options that mirror an underlying fixed income security.

25. The electronic trading platform of claim 22 further comprising a first-in-first-out (FIFO) matching engine.

26. The electronic trading platform of claim 22 further comprising the trade being off balance sheet.

27. The electronic trading platform of claim 22 further comprising, at settlement, open fixed income futures and fixed income options result in the delivery of an underlying fixed income security.

28. The electronic trading platform of claim 22 further comprising, at settlement, fixed income futures and fixed income options being cleared through a centralized clearinghouse.

29. The electronic trading platform of claim 22 further comprising, at settlement, a netting of open fixed income futures and fixed income options.

30. The electronic trading platform of claim 22 further comprising delivery fails that occur as a result of a fail in the fixed income futures or fixed income options occurring in the cash market.

31. The electronic trading platform of claim 22 further comprising a host, a communications server, and a client.

32. An electronic trading platform for cash and cash futures (options) comprising:
a fixed income cash market; and
a fixed income cash futures market;
the fixed income cash market and the fixed income cash futures market being displayed together in a single platform.

33. The electronic trading platform of claim 32 further wherein the cash and cash futures (options) are selected from the group comprising U.S. treasuries, futures on U.S. treasuries, options on U.S. treasuries, and combinations thereof.

34. The electronic trading platform of claim 32 further comprising fixed income futures and fixed income options that mirror an underlying fixed income security.

35. The electronic trading platform of claim 32 further comprising a first-in-first-out (FIFO) matching engine.

36. The electronic trading platform of claim 32 further comprising simultaneous electronic trading among fixed income securities, fixed income futures, and fixed income options markets on a single trading platform.

37. The electronic trading platform of claim 32 further comprising, at settlement, open fixed income futures and fixed income options result in the delivery of an underlying fixed income security.

38. The electronic trading platform of claim 32 further comprising, at settlement, fixed income futures and fixed income options being cleared through a centralized clearinghouse.

39. The electronic trading platform of claim 32 further comprising, at settlement, a netting of open fixed income futures and fixed income options.

40. The electronic trading platform of claim 32 further comprising delivery fails that occur as a result of a fail in the fixed income futures or fixed income options occurring in the cash market.

41. The electronic trading platform of claim 32 further comprising a host, a communications server, and a client.

42. A method of trading cash and cash futures (options) comprising displaying a fixed income cash market and a fixed income cash futures market together in a single platform.

43. The method of trading of claim 42 further including selecting the cash and cash futures (options) from the group comprising U.S. treasuries, futures on U.S. treasuries, options on U.S. treasuries, combinations thereof.

44. The method of trading of claim 42 further comprising fixed income futures and fixed income options that mirror an underlying fixed income security.

45. The method of trading of claim 42 further comprising matching on a first-in-first-out (FIFO) basis.

46. The method of trading of claim 42 further comprising simultaneous electronic trading among fixed income securities, fixed income futures, and fixed income options markets on a single trading platform.

47. The method of trading of claim 42 further comprising, at settlement, open fixed income futures and fixed income options result in the delivery of an underlying fixed income security.

48. The method of trading of claim 42 further comprising, at settlement, fixed income futures and fixed income options being cleared through a centralized clearinghouse.

49. The method of trading of claim 42 further comprising, at settlement, a netting of open fixed income futures and fixed income options.

50. The method of trading of claim 42 further comprising delivery fails that occur as a result of a fail in the fixed income futures or fixed income options occurring in the cash market.

51. The method of trading of claim 42 further comprising a host, a communications server, and a client.

52. An electronic trading platform for cash and cash futures (options) comprising simultaneous electronic displaying of fixed income securities, fixed income futures, and fixed income options markets on a single platform.

53. The electronic trading platform of claim 52 further wherein the cash and cash futures (options) are selected from the group comprising U.S. treasuries, futures on U.S. treasuries, options on U.S. treasuries, and combinations thereof.

54. The electronic trading platform of claim 52 further comprising fixed income futures and fixed income options that mirror an underlying fixed income security.

55. The electronic trading platform of claim 52 further comprising a first-in-first-out (FIFO) matching engine.

56. The electronic trading platform of claim 52 further comprising, at settlement, open fixed income futures and fixed income options result in the delivery of an underlying fixed income security.

57. The electronic trading platform of claim 52 further comprising, at settlement, fixed income futures and fixed income options being cleared through a centralized clearinghouse.

58. The electronic trading platform of claim 52 further comprising, at settlement, a netting of open fixed income futures and fixed income options.

59. The electronic trading platform of claim 52 further comprising delivery fails that occur as a result of a fail in the fixed income futures or fixed income options occurring in the cash market.

60. The electronic trading platform of claim 52 further comprising underlying fixed income security being priced in any currency for delivery anywhere in the world.

61. The electronic trading platform of claim 52 further comprising a host, a communications server, and a client.

62. An electronic trading platform for cash and cash futures (options) comprising:
a fixed income cash market; and
a fixed income cash futures market;
the fixed income cash futures market being aligned with the fixed income cash market.

63. The electronic trading platform of claim 62 further wherein the cash and cash futures (options) are selected from the group comprising U.S. treasuries, futures on U.S. treasuries, options on U.S. treasuries, and combinations thereof.

64. The electronic trading platform of claim 62 further comprising fixed income futures and fixed income options that mirror an underlying fixed income security.

65. The electronic trading platform of claim 62 further comprising a first-in-first-out (FIFO) matching engine.

66. The electronic trading platform of claim 62 further comprising simultaneous electronic trading among fixed income securities, fixed income futures, and fixed income options markets on a single trading platform.

67. The electronic trading platform of claim 62 further comprising, at settlement, open fixed income futures and fixed income options result in the delivery of an underlying fixed income security.

68. The electronic trading platform of claim 62 further comprising, at settlement, fixed income futures and fixed income options being cleared through a centralized clearinghouse.

69. The electronic trading platform of claim 62 further comprising, at settlement, a netting of open fixed income futures and fixed income options.

70. The electronic trading platform of claim 62 further comprising delivery fails that occur as a result of a fail in the fixed income futures or fixed income options occurring in the cash market.

71. The electronic trading platform of claim 62 further comprising a host, a communications server, and a client.

72. A method of trading comprising aligning a fixed income cash futures market with a fixed income cash market.

73. The method of trading of claim 72 further comprising fixed income futures and fixed income options that mirror an underlying fixed income security.

74. The method of trading of claim 72 further comprising matching on a first-in-first-out (FIFO) basis.

75. The method of trading of claim 72 further comprising simultaneous electronic trading among fixed income securities, fixed income futures, and fixed income options markets on a single trading platform.

76. The method of trading of claim 72 further comprising, at settlement, open fixed income futures and fixed income options result in the delivery of an underlying fixed income security.

77. The method of trading of claim 72 further comprising, at settlement, fixed income futures and fixed income options being cleared through a centralized clearinghouse.

78. The method of trading of claim 72 further comprising, at settlement, a netting of open fixed income futures and fixed income options.

79. The method of trading of claim 72 further comprising delivery fails that occur as a result of a fail in the fixed income futures or fixed income options occurring in the cash market.

80. The method of trading of claim 72 further comprising a host, a communications server, and a client.

81. An electronic trading platform for cash and cash futures (options) comprising fixed income futures being traded in an over-the-counter market.

82. The electronic trading platform of claim 81 further wherein the cash and cash futures (options) are selected from the group comprising U.S. treasuries, futures on U.S. treasuries, options on U.S. treasuries, and combinations thereof.

83. The electronic trading platform of claim 81 further comprising fixed income futures and fixed income options that mirror an underlying fixed income security.

84. The electronic trading platform of claim 81 further comprising a first-in-first-out (FIFO) matching engine for the fixed income financial instruments.

85. The electronic trading platform of claim 81 further comprising simultaneous electronic trading among fixed income securities, fixed income futures, and fixed income options markets on a single trading platform.

86. The electronic trading platform of claim 81 further comprising, at settlement, open fixed income futures and fixed income options result in the delivery of an underlying fixed income security.

87. The electronic trading platform of claim 81 further comprising, at settlement, fixed income futures and fixed income options being cleared through a centralized clearinghouse.

88. The electronic trading platform of claim 81 further comprising, at settlement, a netting of open fixed income futures and fixed income options.

89. The electronic trading platform of claim 81 further comprising delivery fails that occur as a result of a fail in the fixed income futures or fixed income options occurring in the cash market.

90. The electronic trading platform of claim 81 further comprising a host, a communications server, and a client.

91. A method of trading comprising enabling trading of fixed income futures in an over-the-counter market.

92. The method of trading of claim 91 further comprising fixed income futures and fixed income options that mirror an underlying fixed income security.

93. The method of trading of claim 91 further comprising price improvement wherein if a user attempts to buy or sell at one rate and price improves during the execution process, the user will receive the benefit of the improved price.

94. The method of trading of claim 91 further comprising matching on a first-in-first-out (FIFO) basis.

95. The method of trading of claim 91 further comprising simultaneous electronic trading among fixed income securities, fixed income futures, and fixed income options markets on a single trading platform.

96. The method of trading of claim 91 further comprising, at settlement, open fixed income futures and fixed income options result in the delivery of an underlying fixed income security.

97. The method of trading of claim 91 further comprising, at settlement, fixed income futures and fixed income options being cleared through a centralized clearinghouse.

98. The method of trading of claim 91 further comprising, at settlement, a netting of open fixed income futures and fixed income options.

99. The method of trading of claim 91 further comprising delivery fails that occur as a result of a fail in the fixed income futures or fixed income options occurring in the cash market.

100. The method of trading of claim 91 further comprising a host, a communications server, and a client.

101. An electronic trading platform comprising automatic matching of bids and offers for cash and cash futures (options).

102. The electronic trading platform of claim 101 further comprising fixed income futures and fixed income options that mirror an underlying fixed income security.

103. The electronic trading platform of claim 101 further comprising price improvement wherein if a user attempts to buy or sell at one rate and price improves during the execution process, the user will receive the benefit of the improved price.

104. The electronic trading platform of claim 101 further comprising a first-in-first-out (FIFO) matching engine.

105. The electronic trading platform of claim 101 further comprising simultaneous electronic trading among fixed income securities, fixed income futures, and fixed income options markets on a single trading platform.

106. The electronic trading platform of claim 101 further comprising, at settlement, open fixed income futures and fixed income options result in the delivery of an underlying fixed income security.

107. The electronic trading platform of claim 101 further comprising, at settlement, fixed income futures and fixed income options being cleared through a centralized clearinghouse.

108. The electronic trading platform of claim 101 further comprising, at settlement, a netting of open fixed income futures and fixed income options.

109. The electronic trading platform of claim 101 further comprising delivery fails that occur as a result of a fail in the fixed income futures or fixed income options occurring in the cash market.

110. The electronic trading platform of claim 101 further comprising a host, a communications server, and a client.

111. A method of trading comprising enabling automatic matching of bids and offers for cash and cash futures (options).

112. The method of trading of claim 111 further comprising fixed income futures and fixed income options that mirror an underlying fixed income security.

113. The method of trading of claim 111 further comprising a first-in-first-out (FIFO) matching engine.

114. The method of trading of claim 111 further comprising simultaneous electronic trading among fixed income securities, fixed income futures, and fixed income options markets on a single trading platform.

115. The method of trading of claim 111 further comprising, at settlement, open fixed income futures, and fixed income options result in the delivery of an underlying fixed income security.

116. The method of trading of claim 111 further comprising, at settlement, fixed income futures and fixed income options being cleared through a centralized clearinghouse.

117. The method of trading of claim 111 further comprising, at settlement, a netting of open fixed income futures and fixed income options.

118. The method of trading of claim 111 further comprising delivery fails that occur as a result of a fail in the fixed income futures or fixed income options occurring in the cash market.

119. The method of trading of claim 111 further comprising a host, a communications server, and a client.

120. A financial instrument comprising an over-the-counter futures contract that delivers a specific treasury security at a specific futures date using cash market delivery methods.

121. The financial instrument of claim 120 further wherein the over-the-counter futures contract comprises a single issue standardized forward treasury futures contract.

122. The financial instrument of claim 120 further wherein the over-the-counter futures contract is centrally cleared.

123. The financial instrument of claim 120 further wherein delivery of an underlying asset of the over-the-counter futures contract is netted and settled in the spot market.
